(19) United States
(12) Patent Application Publication
(10) Pub. No.: US 2014/0012950 A1
(43) Pub. Date: Jan. 9, 2014

(54) CLOUD BASED REMOTE CONTROL SYSTEM

(71) Applicants: Bruce Allen Doucette, Highlands Ranch, CO (US); Joyce Mirenzi, Highlands Ranch, CO (US); Mark Andrew Doucette, San Antonio, TX (US); Cheri Lynn Wyman, Littleton, CO (US)

(72) Inventors: Bruce Allen Doucette, Highlands Ranch, CO (US); Joyce Mirenzi, Highlands Ranch, CO (US); Mark Andrew Doucette, San Antonio, TX (US); Cheri Lynn Wyman, Littleton, CO (US)

(21) Appl. No.: 13/853,995

(22) Filed: Mar. 29, 2013

Related U.S. Application Data
(60) Provisional application No. 61/617,801, filed on Mar. 30, 2012.

(51) Int. Cl. G06F 15/173

(52) U.S. Cl. CPC G06F 15/173
USPC 709/218

(57) ABSTRACT

This proposed invention provides an efficient, secure cloud based remote control system for remote controlling all electronic or electromagnetically controlled devices, data and photos from anywhere in the world, giving consumers the ability to live global lifestyles while maintaining control of their devices and data from one complete system. Unique to this system is the standard set of remote controls for all electronic and electromagnetically controlled devices, eliminating the need for different remote control systems for different devices. The standard set of remote controls has the capability to become a standard by which all devices can be manufactured in the future to seamlessly connect to all remote control systems containing the same set of standard remote controls, much like Bluetooth has become the wireless standard for cell phones, computers and laptops. This cloud based remote control system is based on the Personal Universe Control System (PUCS) Standard.

This application claims the benefit of Application Ser. No. 61/617,801 of Bruce Doucette, Mark Doucette, Joyce Mirenzi, Cheri Wyman, filed Mar. 30, 2012 for PERSONAL UNIVERSE CONCEPT, the contents of which are herein incorporated by reference. Confirmation number is 2444 of provisional patent receipt.

The proposed invention is a cloud based remote control system using a set of standard remote controls to allow any electronic or electromagnetically controlled device to be remotely controlled from anywhere in the world. The said system can be accessed or controlled by any electronic device, display device, or by voice command on a phone, or mind control device, that are able to be used to access the world wide web (internet) through telephone lines, cellular networks, satellite networks, or any other network interface available to access the world wide web (internet), thus giving the user the ability to virtually control that device, regardless of the location of that device or the location of the user. Currently, there exists technology whereby personal and business office data and photos can be stored virtually using cloud computing. What makes this invention unique and different is that, in addition to data and photo storage, a user will be able to virtually and remotely control all of their electronic or electromagnetically controlled devices no matter where those devices are located (eliminating the need for multiple systems for multiple locations), all their data or photos that they assign and install into their remote control system, from only one system from anywhere in the world, eliminating the need for several systems to perform specific functions for specific devices or specific data. This system will be a user's “one stop shop” to control everything important to them. Unlike typical cloud computing where there are many avenues available to access data stored in the cloud, once a user has their remote control system set up, there will be only one gateway to access it which makes it a more secure system. The one gateway to each device will be accessible by one or more authorized users of the remote control system. The number of users can be designated or limited to increase security. In addition, security can be increased within the system by limiting access and permission to certain features to only specific users. An example of this would be a parent denying their children permission within the remote control system to access bank account information.

For the purpose of this patent a user's “environment” according to this remote control system is defined as any data, photos or device that can be electronically controlled or electromagnetically controlled, including but not limited to electromagnetically controlled devices in their home, their office, their vehicle or anywhere they choose to place their devices. Examples would be the ability to remotely control light switches, alarms, televisions, thermostats, appliances, electronic equipment, heating and air conditioning units, sprinkler systems, water valves and plumbing lines, vehicles, just about any item that can be electronically or electromagnetically controlled. The remote control system has active connections to all types of communication, be it the Internet (world wide web), cellular networks or satellite networks, to name a few. Any hardware device designed using the PUCS standard can be automatically installed (auto-configured) and controlled. This auto-configuration eliminates human error in having to manually input the lengthy IPv6 unique identifying addresses, in addition to assigning the available controls for that particular device. Not only will this technology aid in emergency situations that used to be out of one's control because the user was not physically at the emergency site, but this technology will now enable users to have the personal freedom to truly live a “global” lifestyle while still being able to maintain control of their office environment, personal environment, home environment, or whatever environment they wish to control, wherever it or they may be located in the world. In addition to being able to remotely control hardware devices, one will be able to remotely store, maintain, and organize any data, health records, online accounts, photos, and files so that everything is always available and protected, and this can be done remotely from anywhere in the world using any input device such as electronic device, display device, or by voice command on a phone, mind control device, or other devices that are able to be used to access the world wide web (internet) through telephone lines, cellular networks, satellite networks, or any other network interface available to access the world wide web (internet). This enables a user to have one secure central location where everything they want to control in their life and all of the information that is important to them is located and controlled by one universal system. A future possibility is that as users and manufacturers recognize the ease with which this cloud based remote control system gives consumers control of what is most important to them, then manufacturers of products will begin making them compatible with this remote control system so they seamlessly connect to the system. The consumer then knows that when they purchase a product that is certified to be manufactured to the Personal Universe standards that it can be controlled anywhere in the world by any Personal Universe hardware or remote control system. There are many electronic or electromagnetically controlled devices in existence currently that can be made compatible with this cloud based remote control system by simply upgrading the BIOS in the device so that these devices can be put into use immediately.

The public domain is even larger in spectrum. This cloud based remote control system can be broadened in scope to include commercial applications. Companies will be able to control unmanned vehicles, public transportation, commercial or private aircraft, manufacturing plants, assembly lines, robotic equipment, public building system controls, fire and safety systems, to name a few, as well as remotely maintaining and organizing any data programs and records associated with the businesses.

This cloud based remote control system will allow equipment manufacturers and software developers to design their products to seamlessly connect to this remote control system, allowing for a universal standard that all hardware and software can be manufactured under in the future. Any hardware or software designed using the remote control system specifications and standards will automatically work within the remote control system. This patent proposes the use of a standardized system by which software companies and manufacturing companies of Personal Universe Control System (PUCS) compatible equipment alike will adhere to the same specifications and standards so that all equipment and software is universally compatible with the Personal Universe Control System (PUCS), much like Bluetooth has become the wireless standard for cell phones, computers and laptops.

The fundamental design of the Personal Universe Control System (remote control system) is to allow users to easily purchase and then automatically install any compatible device into their cloud based remote control system so that particular device can be remotely controlled from anywhere in the world regardless of the device's physical location or the user's physical location. When a user purchases a new device (such as an internet television/video system, light switch, water valve, etc.), the user would scan the device into their remote control system and then the remote control system will ask the user to assign their unique name to that device (for example, “living room TV”, “main water valve”, “porch light switch”, etc). At that point, the remote control system will contact the new device through its unique identifying address like IP address and assign the user's unique Personal Universe ID code and all routing information necessary to control the device from anywhere in the world. The remote control system will automatically configure the device for use with that user's Personal Universe. Once this function is performed, the only internet communications that will be allowed by that device will come from their Personal Universe, or from the remote control supplied with the device by the manufacturer, or from the actual manual controls on the device itself, therefore making the device impossible for outside intervention (hacking).

Once the device is installed into the remote control system, the user can then control that device from anywhere in the world using any input device such as electronic device, display device, or by voice command on a phone, mind control device, or other devices that are able to be used to access the world wide web (internet) through telephone lines, cellular networks, satellite networks, or any other network interface that is available to access the world wide web (internet). The Personal Universe standards will act in a similar manner in the industrial arena for public buildings, security and fire systems, assembly lines, robotic equipment, private and commercial aircraft, manufacturing plants, etc., with any device that can be modified or configured to be controlled remotely. As time goes on and the benefits of the Personal Universe standards take hold throughout the globe, more and more devices will be manufactured or reconfigured to be compatible with the Personal Universe standards to a point where the Personal Universe standards become “the standard” by which most devices are manufactured. This concept for the cloud based remote control system presented in this patent is based on the PUCS standard and has the capability of changing forever the way the world operates, by giving users the freedom to travel the globe, yet maintain critical control of their data, records, photos and a multitude of devices both personally and commercially.

### TECHNICAL FIELD

Terms and definitions for ease in understanding what is presented:

### Personal Universe Control System (PUCS).

This is the name of the standard we have assigned to the cloud based remote control system. We refer to it as the PUCS which contains a universal set of remote controls to remotely control all electronic or electromagnetically controlled devices. For example, the controls in the remote control system that turn a device “on” or “off” are the same for all devices.

### Personal Universe.

A user's “Personal Universe” is defined as all the specific things they wish to be able to remotely control. For example, all their data, medical records, photos, or any electronic or electromagnetically controlled device they want to configure into their cloud based remote control system, including but not limited to electromagnetically controlled devices in their home, their office, their vehicle or anywhere they choose to physically place their devices. All of these data, photos, and devices are part of their “environment” of which they will be able to remotely control once these items are installed into their system. Examples would be the ability to control light switches, alarms, televisions, thermostats, appliances, electronic equipment, heating and air conditioning units, sprinkler systems, water valves and plumbing lines, vehicles, just about any item that can be electronic or electromagnetically controlled. Once these items are installed into their cloud based remote control system the user will be able to gain remote control from anywhere and access their system using any electronic device, display device, or by voice command on a phone, or mind control device, that are able to be used to access the world wide web (internet) through telephone lines, cellular networks, satellite networks, or any other network that is able to access the world wide web.

### Environment.

A user's “environment” according to this remote control system is defined as any data, photos or device that can be electronically controlled or electromagnetically controlled, including but not limited to electromagnetically controlled devices in their home, their office, their vehicle or anywhere they choose to place their devices. Examples would be the ability to remotely control light switches, alarms, televisions, thermostats, appliances, electronic equipment, heating and air conditioning units, sprinkler systems, water valves and plumbing lines, vehicles, just about any item that can be electronically or electromagnetically controlled.

### Electronic Device.

Defined as any electronic or electromagnetically controlled device or a device that is capable of being remotely controlled.

### Control Device.

Defined as a computing device, display device, or by voice command on a phone, or mind control device, that can remotely control other devices and data in its environment when those devices are not directly connected to the system.

### Alpha-Numeric Unique Identifying Address.

This cloud based remote control system uses a two-part unique identifying address for each electronic device. The first part is an alphabetic designation by which the remote control system determines what standard controls are available for that device with that particular alphabetic designation in the remote control system. The second part of the address is numeric like the unique IP address for each electronic device and this determines exactly which device is to be controlled. A table within the cloud based remote control system contains a list of alpha codes corresponding to devices and what standard controls are available for each alpha code and its corresponding device. New alpha codes for new devices can always be added to the system along with the standard remote controls for each particular device that corresponds to the new alpha code. (For example: TVV[alpha]12345 [IP address] may identify this device as a television with built-in video and the system would know which controls are available by that particular alphabetic prefix. The numeric portion is the device's IP address or similar unique identifying address for that particular device.)

### Install a Device.

Defined as configuring an electronic or electromagnetically controlled device so that it can communicate with the controls of the system to allow the device to be remotely controlled or monitored.

This invention relates generally to personal and commercial remote control systems used to remotely control electronic and electromagnetically controlled devices and data. The proposed cloud-based remote control system presented in this patent can be accessed or controlled by any electronic device, display device, or by voice command on a phone, or mind control device, that are able to be used to access the world wide web (internet) through telephone lines, cellular networks, satellite networks, or any other network interface available to access the world wide web (internet). This cloud based remote control system also provides a standard set of remote controls by which all electronic and electromagnetically controlled devices can be remotely controlled from anywhere regardless of the location of the device or the user. The proposed remote control system contains a method of auto-configuring devices into the system as well as having a security measure to eliminate outsiders from obtaining access to the system. Because all devices can be controlled from just one system, the devices can interact with one another. Electronic or electromagnetically controlled devices already in existence can be reconfigured to be compatible with this cloud based remote control system so they can be put into use immediately.

The proposed invention is a cloud based remote control system using a set of standard remote controls to allow any electronic or electromagnetically controlled device to be remotely controlled from anywhere in the world. The said system can be accessed or controlled by any electronic device, display device, or by voice command on a phone, or mind control device, that are able to be used to access the world wide web (internet) through telephone lines, cellular networks, satellite networks, or any other network interface available to access the world wide web (internet), thus giving the user the ability to virtually control that device, regardless of the location of that device or the location of the user.

For the purpose of this patent a user's “environment” according to this remote control system is defined as any data, photos or device that can be electronically controlled or electromagnetically controlled, including but not limited to electromagnetically controlled devices in their home, their office, their vehicle or anywhere they choose to place their devices. Examples would be the ability to remotely control light switches, alarms, televisions, thermostats, appliances, electronic equipment, heating and air conditioning units, sprinkler systems, water valves and plumbing lines, vehicles, just about any item that can be electronically or electromagnetically controlled. The remote control system has active connections to all types of communication, be it the Internet (world wide web), cellular networks or satellite networks, to name a few. Any hardware device designed using the PUCS standard can be automatically installed (auto-configured) and controlled. This auto-configuration eliminates human error in having to manually input the lengthy IPv6 unique identifying addresses, in addition to assigning the available controls for that particular device. Not only will this technology aid in emergency situations that used to be out of one's control because the user was not physically at the emergency site, but this technology will now enable users to have the personal freedom to truly live a “global” lifestyle while still being able to maintain control of their office environment, personal environment, home environment, or whatever environment they wish to control, wherever it or they may be located in the world.

In addition to being able to remotely control hardware devices, one will be able to remotely store, maintain, and organize any data, health records, online accounts, photos, and files so that everything is always available and protected, and this can be done remotely from anywhere in the world using any input device such as electronic device, display device, or by voice command on a phone, mind control device, or other devices that are able to be used to access the world wide web (internet) through telephone lines, cellular networks, satellite networks, or any other network interface available to access the world wide web (internet). This enables a user to have one secure central location where everything they want to control in their life and all of the information that is important to them is located and controlled by one universal system. A future possibility is that as users and manufacturers recognize the ease with which this cloud based remote control system gives consumers control of what is most important to them, then manufacturers of products will begin making them compatible with this remote control system so they seamlessly connect to the system. The consumer then knows that when they purchase a product that is certified to be manufactured to the Personal Universe standards that it can be controlled anywhere in the world by any Personal Universe hardware or remote control system.

There are many electronic or electromagnetically controlled devices in existence currently that can be made compatible with this cloud based remote control system by simply upgrading the BIOS in the device so that these devices can be put into use immediately.

The fundamental design of the Personal Universe Control System (remote control system) is to allow users to easily purchase and then automatically install any compatible device into their cloud based remote control system so that particular device can be remotely controlled from anywhere in the world regardless of the device's physical location or the user's physical location. When a user purchases a new device (such as an internet television/video system, light switch, water valve, etc.), the user would scan the device into their remote control system and then the remote control system will ask the user to assign their unique name to that device (for example, “living room TV”, “main water valve”, “porch light switch”, etc). At that point, the remote control system will contact the new device through its unique identifying address like IP address and assign the user's unique Personal Universe ID code and all routing information necessary to control the device from anywhere in the world. The remote control system will automatically configure the device for use with that user's Personal Universe. Once this function is performed, the only internet communications that will be allowed by that device will come from their Personal Universe, or from the remote control supplied with the device by the manufacturer, or from the actual manual controls on the device itself, therefore making the device impossible for outside intervention (hacking).

Once the device is installed into the remote control system, the user can then control that device from anywhere in the world using any input device such as electronic device, display device, or by voice command on a phone, mind control device, or other devices that are able to be used to access the world wide web (internet) through telephone lines, cellular networks, satellite networks, or any other network interface that is available to access the world wide web (internet). The Personal Universe standards will act in a similar manner in the industrial arena for public buildings, security and fire systems, assembly lines, robotic equipment, private and commercial aircraft, manufacturing plants, etc., with any device that can be modified or configured to be controlled remotely. As time goes on and the benefits of the Personal Universe standards take hold throughout the globe, more and more devices will be manufactured or reconfigured to be compatible with the Personal Universe standards to a point where the Personal Universe standards become “the standard” by which most devices are manufactured.

### SUMMARY OF INVENTION

It is an object of the present invention proposed in this patent to provide a cloud based remote control system whereby users are able to remotely control all of their electronic or electromagnetically controlled devices, data and photos, from anywhere in the world regardless of where the user or the device is located. The system can be accessed or controlled by any electronic device, display device, or by voice command on a phone, or mind control device, that are able to be used to access the world wide web (internet) through telephone lines, cellular networks, satellite networks, or any other network interface available to access the world wide web (internet). The system embodies security measures to eliminate outside intervention of the system, auto-configuration of devices for ease of installation, a set of standard remote controls for all electronic devices, a way for electronic devices to interact with one another, and a method to upgrade current electronic or electromagnetically controlled devices with unique identifying addresses so that they can be compatible with the system and put into use immediately. This system has the capability to become a new standard by which all electronic or electromagnetically controlled devices can be manufactured in the future to seamlessly interact with the system, permitting users to have freedom to live a global lifestyle while maintaining control of all of their electronic devices, data, and photos no matter where the user is located or where their devices are located.

The scope of this cloud based remote control system is designed to be used for both personal and commercial applications such as for use in remote control of unmanned vehicles, robotics, manufacturing, public transportation, fire and security systems, etc., just to name a few. The proposed cloud based remote control system allows devices and data to interact in ways never before possible. The possibilities are now limitless on how devices and data can interact. One example would be (but not limited to) a car crashing can cause a user's contact list of loved ones designated in the user's system to receive a text or phone call immediately, with the GPS location of the car (crash location), as well as the status of the car's air bags, orientation of the car, or a video from the car could be sent to a designated television or to a user's designated family member(s) or designated friend's cell phone (or all three) regardless of where the designated contacts are located at the time or where the car crash is located in the world. These emergency designations are done by pre-setting parameters in the system upon initial set up of a user's system and emergency contact instructions within the system. The user involved in the crash does not have to initiate the texts or phone calls as they may be in a state of unconsciousness. The system will carry out whatever emergency instructions the user has set up in the system.

### Technical Problem

Currently no standard exists in the remote control system industry to be able to remotely control all electronic or electromagnetically controlled devices. Electronic or electromagnetically controlled devices are not compatible with all remote control systems. Each manufactured device is governed by a different remote control system. The proposed cloud based remote control system in this invention will provide a standard set of remote controls which will allow all electronic or electromagnetically controlled devices to be controlled from one cloud based remote control system.

### Solution to Problem

Currently, a company providing remote control service for electronic or electromagnetically controlled devices uses their particular remote control system to control the electronic or electromagnetically controlled devices. This makes it cumbersome for a consumer to change remote control companies because currently not all devices can be controlled by all systems. This can be a costly expense to the consumer to change service from one company to another if the hardware is not compatible with the new remote control system.

The cloud based remote control system presented in this patent eliminates that problem as this system uses a standard set of remote controls for all devices and any cloud based remote control system designed using this standard set of remote controls will seamlessly communicate with all devices, allowing them to be remotely controlled from anywhere in the world because the system is based in the cloud. This concept for the cloud based remote control system presented in this patent is based on the PUCS standard and has the capability of changing forever the way the world operates, by giving users the freedom to travel the globe, yet maintain critical control of their data, records, photos and a multitude of devices both personally and commercially.

Currently, there exists technology whereby personal and business office data and photos can be stored virtually using cloud computing. What makes this invention unique and different is that, in addition to data and photo storage, a user will be able to virtually and remotely control all of their electronic or electromagnetically controlled devices no matter where those devices are located (eliminating the need for multiple systems for multiple locations), all their data or photos that they assign and install into their remote control system, from only one system from anywhere in the world, eliminating the need for several systems to perform specific functions for specific devices or specific data. This system will be a user's “one stop shop” to control everything important to them. Unlike typical cloud computing where there are many avenues available to access data stored in the cloud, once a user has their remote control system set up, there will be only one gateway to access it which makes it a more secure system. The one gateway to each device will be accessible by one or more authorized users of the remote control system. The number of users can be designated or limited to increase security. In addition, security can be increased within the system by limiting access and permission to certain features to only specific users. An example of this would be a parent denying their children permission within the remote control system to access bank account information.

### Advantageous Effects of Invention

The advantages of this patent is to allow a standard set of binary controls to remotely control all electronic or electromagnetically controlled devices.

### BRIEF DESCRIPTION OF DRAWINGS

FIG. 1 The description of the cloud based remote control system showing some of the connections available as well as some of the different groups of devices that can be remotely controlled by the system.

FIG. 2-A shows the steps required to install and setup a new control device in said system.

FIG. 2-B shows the steps required to install and setup a new device using a control device already installed in said system.

FIG. 2-C shows how broadcasting is turned off, allowing only the cloud based remote control system to control the device, adding additional level of security.

FIG. 3 is a flow chart showing a typical control of a device.

FIG. 4 shows network connections to the cloud based remote control system.

FIG. 5 shows typical flow of log on to the cloud based remote control system.

### DESCRIPTION OF EMBODIMENTS

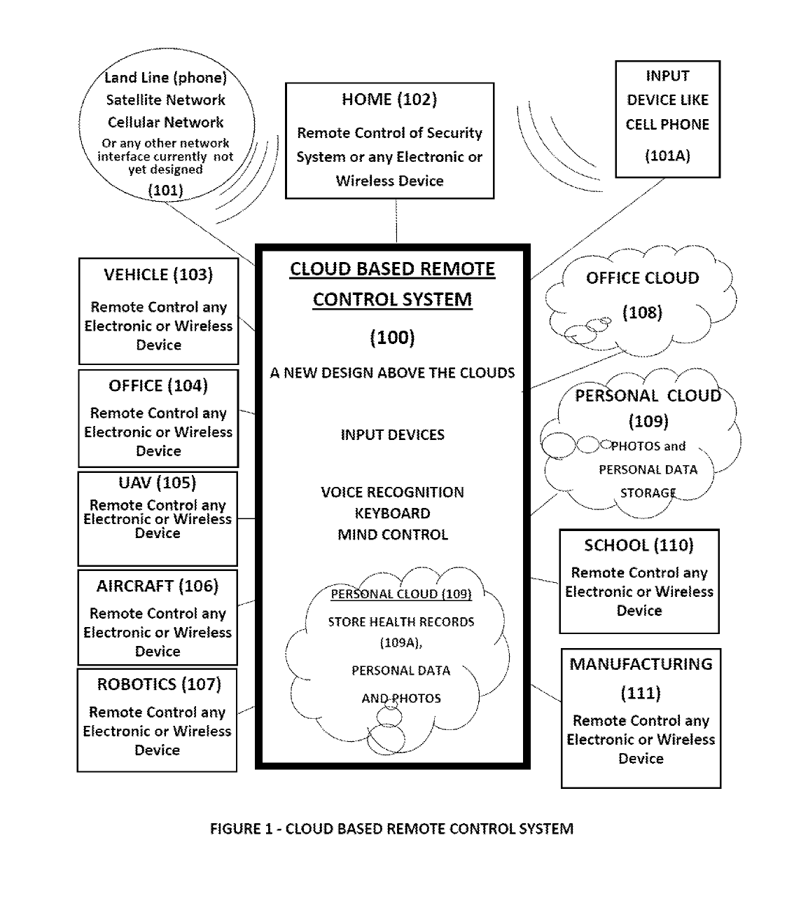

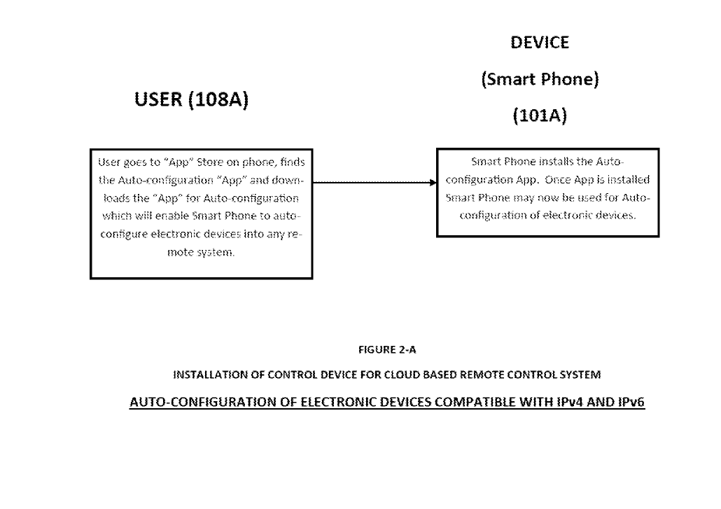

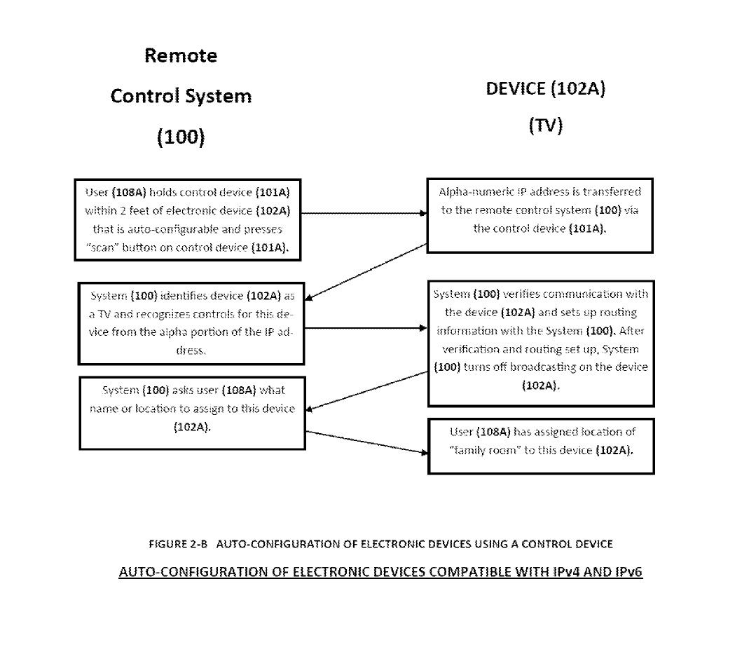

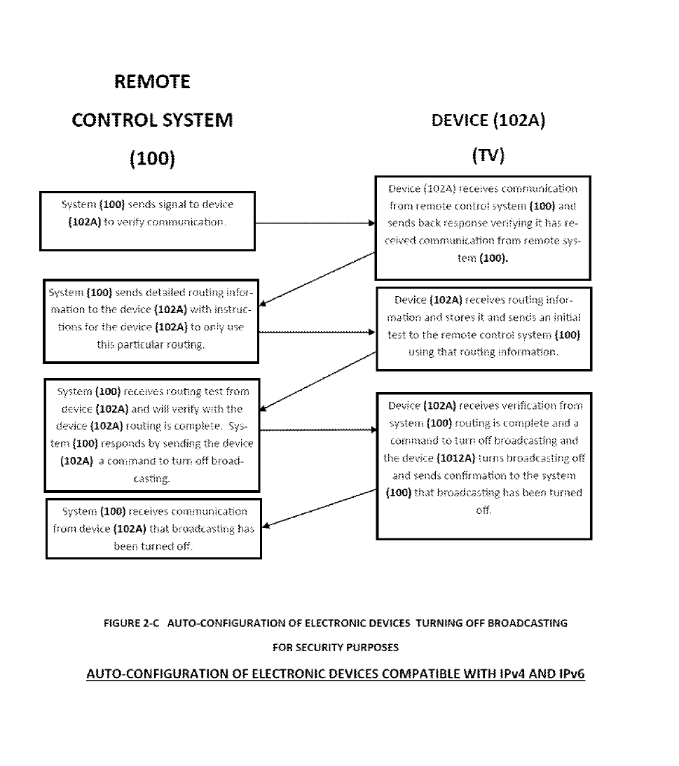

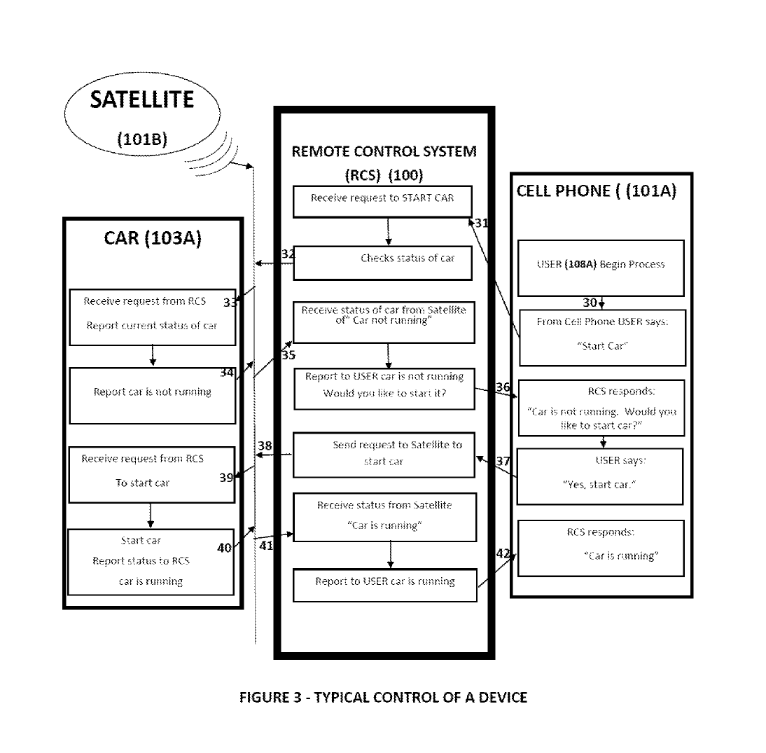

FIG. 1 shows the Cloud Based Remote Control System (100) diagram where the system (100) in this Patent is comprised of the cloud based remote control system (100) and any electronic or electromagnetically controlled device in a home (102) or any devices or data located in or connected to a home (102), or a vehicle (103) or any devices or data located in or connected to a vehicle (103), office (104) or any devices or data located in or connected to an office (104), or a UAV (unmanned aerial vehicle) (105) or any devices or data located in or connected to a UAV (105), an Aircraft (106) or any devices or data located in or connected to an Aircraft (106), Robotics (107) or any devices located in or connected to the Robotics (107), Office Cloud (108) or any devices or data located in or connected to the Office Cloud (108), Personal Cloud (109) or any devices or data located in or connected to the Personal Cloud (109), Health Records (109A) or any devices or data located in or connected to the Health Records (109A), School (110) or any devices or data located in or connected to the School (110), Manufacturing (111) or any devices or data located in or connected to the Manufacturing (111), or any other data, device or “environment” not yet specified. The devices and said Cloud based Remote Control system (100) can be accessed and controlled from anywhere in the world using a control device (101A) or any input device such as electronic device, display device, or by voice command on a phone, that is available to access the world wide web (internet), that are able to be used to access the world wide web (internet) through telephone lines, cellular networks, satellite networks, or any other network interface (101) that is available to access the world wide web (internet). Whereby said system (100) allows for unlimited interactions of devices and data, allowing other benefits in addition to being able to just remotely control devices. Users can now have devices or data trigger or control other devices or data, allowing for triggered events, command events, calendar events, and logged events. The intent of this patent is to provide a new system design and standard whereby all new devices can be manufactured and remotely controlled without the need to develop or design external remote systems. In addition, any devices designed using these standards in this design patent, can be automatically installed and controlled from anywhere in the world such as but not limited to the TV (102A) FIG. 2-B, Smart Phone (101A) FIG. 2-A, or Car (103A) FIG. 3.

FIG. 2-A shows the auto configuration of a typical installation of a control device (see definition of control device in “Definitions” in this patent) into the cloud based remote control system (100) in FIG. 1. The diagram shows a User (108A) downloads an application from the cloud based remote control system (100) in FIG. 1 accessing the system (100) through the world wide web (internet) through a plurality of interfaces such as but not limited to telephone lines, cellular networks, satellite networks, or any other network interface available to access the world wide web (internet), for auto-configuring devices into the cloud based remote control system (100) in FIG. 1. The user's phone (101A) receives through the world wide web (internet) through a plurality of interfaces such as but not limited to telephone lines, cellular networks, satellite networks, or any other network interface available to access the world wide web (internet), the application configuration from the system (100) and then the phone (101A) installs the application configuration received from the cloud based remote control system (100) in FIG. 1 and the application from system (100) automatically configures the phone (101A) so that the phone (101A) can be used as a control device (much like a remote control) to communicate with the system (100) to auto-configure future devices into the system (100).

FIG. 2-B shows how to auto configure and install a new device into the Cloud Based Remote Control System (100) in FIG. 1 using an already installed control device (101A) in FIG. 2-A. User (108A) holds control device (101A) within 2 feet of electronic device (102A) that is auto-configurable and presses “scan” button on the control device (101A). The control device (101A) reads the alpha-numeric IP address on the electronic device (102A) and transfers the alpha-numeric address to the system (100) accessing the system (100) through the world wide web (internet) through a plurality of interfaces such as but not limited to telephone lines, cellular networks, satellite networks, or any other network interface available to access the world wide web (internet). The system (100) receives the information from the control device (102A) through the world wide web (internet) through a plurality of interfaces such as but not limited to telephone lines, cellular networks, satellite networks, or any other network interface that is available to access the world wide web (internet), and identifies the new device (102A) as a TV from reading the alpha portion of the alpha-numeric identifying code (alpha code plus IP address) on the device (102A). The system (100) then identifies the standard controls for that device (102A) and assigns the standard controls for that device (102A) to the device (102A), transmitting the controls for the new device (102A) to the new device (102A) through the world wide web (internet) through a plurality of interfaces such as but not limited to telephone lines, cellular networks, satellite networks, or any other network interface that is available to access the world wide web (internet). New device (102A) receives the control information from the system (100) through the world wide web (internet) through a plurality of interfaces such as but not limited to telephone lines, cellular networks, satellite networks, or any other network interface that is available to access the world wide web (internet). System (100) verifies communication with the device (102A) through the world wide web (internet) through a plurality of interfaces such as but not limited to telephone lines, cellular networks, satellite networks, or any other network interface that is available to access the world wide web (internet), and sets up routing information between the device (102A) and the system (100). After the system (100), using the world wide web (internet) through a plurality of interfaces such as but not limited to telephone lines, cellular networks, satellite networks, or any other network interface that is accessible to access the world wide web (internet), verifies communication and routing set up with the device (102A), then the system (100) turns off broadcasting on the device (102A) so the device (102A) can only communicate directly with the system (100), thus eliminating any outside interference and making the communication between system (100) and device (102A) secure. The system (100) using the world wide web (internet) through a plurality of interfaces such as but not limited to telephone lines, cellular networks, satellite networks, or any other network interface that is available to access the world wide web (internet) will ask the user (108A) through the control device (101A) what unique name or location the user (108A) wants to assign to the device (102A). Using the control device (101A) user (108A) assigns “family room” location to the device (102A). Control device (101A) sends this information to system (100) from user (108A), using the world wide web (internet) through a plurality of interfaces such as but not limited to telephone lines, cellular networks, satellite networks, or any other network interface that is available to access the world wide web (internet) to communicate to the system (100) the user' (108A) response. System (100) receives through the world wide web (internet) through a plurality of interfaces such as but not limited to telephone lines, cellular networks, satellite networks, or any other network interface that is available to access the world wide web (internet) the response from user (108A) via the control device (101A). The system (100) now assigns user's (108A) unique name of “family room” to device (102A). In future, when user (108A) through a control device (101A) refers to this device (102A) as “family room TV” to the system (100), system (100) will know exactly which device to remotely control by connecting user's (108A) unique identifying name “family room TV” for the device (102A) and the alpha-numeric unique identifying code on the device (102A) itself.

FIG. 2-C shows a flow chart of turning off broadcasting of a device for additional security. System (100) sends a signal to device (102A) through the world wide web (internet) through a plurality of interfaces such as but not limited to telephone lines, cellular networks, satellite networks, or any other network interface available to access the world wide web (internet), to verify communication between the system (100) and the device (102A). The device (102A) receives communication from the system (100) through the world wide web (internet) through a plurality of interfaces such as but not limited to telephone lines, cellular networks, satellite networks, or any other network interface that is available to access the world wide web (internet) to verify that system (100) and device (102A) are now communicating. Device (102A) sends back response to system (100) through the world wide web (internet) through a plurality of interfaces such as but not limited to telephone lines, cellular networks, satellite networks, or any other network interface that is available to access the world wide web (internet) verification of communication. System (100) sends detailed routing information to the device (102A) through the world wide web (internet) through a plurality of interfaces such as but not limited to telephone lines, cellular networks, satellite networks, or any other network interface that is available to access the world wide web (internet) with instructions for the device (102A) to only use the routing information to and from the system (100). The device (102A) receives the routing information from the system (100) through the world wide web (internet) through a plurality of interfaces such as but not limited to telephone lines, cellular networks, satellite networks, or any other network interface that is available to access the world wide web (internet), stores the routing information from system (100), then sends an initial communication test back to the system (100) through the world wide web (internet) through a plurality of interfaces such as but not limited to telephone lines, cellular networks, satellite networks, or any other network interface that is available to access the world wide web (internet) only using the routing information received by the system (100). System (100) receives the communication using the direct routing information from the device (102A) through the world wide web (internet) through a plurality of interfaces such as but not limited to telephone lines, cellular networks, satellite networks, or any other network interface accessible to access the world wide web (internet). System (100) then verifies with the device (102A) through the world wide web (internet) through a plurality of interfaces such as but not limited to telephone lines, cellular networks, satellite networks, or any other network interface that is available to access the world wide web (internet) that the routing is complete. System (100) responds by sending to the device (102A) through the world wide web (internet) through a plurality of interfaces such as but not limited to telephone lines, cellular networks, satellite networks, or any other network interface that is available to access the world wide web (internet) a command to turn off broadcasting. The device (102A) receives from the system (100) through the world wide web (internet) through a plurality of interfaces such as but not limited to telephone lines, cellular networks, satellite networks, or any other network interface that is available to access the world wide web (internet) verification that routing is complete and the command from the system (100) to turn off broadcasting. Device (102A) turns off broadcasting and sends confirmation that broadcasting has been turned off to the system (100) through the world wide web (internet) through a plurality of interfaces such as but not limited to telephone lines, cellular networks, satellite networks, or any other network interface that is available to access the world wide web (internet) that broadcasting has been turned off. System (100) receives communication from device (102A) through the world wide web (internet) through a plurality of interfaces such as but not limited to telephone lines, cellular networks, satellite networks, or any other network interface that is available to access the world wide web (internet) that broadcasting has been turned off.

FIG. 3 shows the typical remote control function of a device to remotely start a car using a cell phone. User (108A) using a control device (101A) (cell phone) verbally says “start car” (30). Cell phone (control device) (101A) sends a request (31) to system (100) through the world wide web (internet) through a plurality of interfaces such as but not limited to telephone lines, cellular networks, satellite networks, or any other network interface that is available to access the world wide web (internet) to “start the car.” System (100) receives the request (31) from the user (108A) via the control device (101A) through the world wide web (internet) through a plurality of interfaces such as but not limited to telephone lines, cellular networks, satellite networks, or any other network interface that is available to access the world wide web (internet) to “start the car”. System (100) sends communication (32) to car (103A) through the world wide web (internet) through a plurality of interfaces such as but not limited to telephone lines, cellular networks, satellite networks, or any other network interface that is available to access the world wide web (internet) requesting status (33) of car. Car (103A) communicates status (34) to system (100) through the world wide web (internet) through a plurality of interfaces such as but not limited to telephone lines, cellular networks, satellite networks, or any other network interface that is available to access the world wide web (internet) that status of car is ‘car not running’. System (100) receives status (35) from car (103A) through the world wide web (internet) through a plurality of interfaces such as but not limited to telephone lines, cellular networks, satellite networks, or any other network interface that is available to access the world wide web (internet) that “car is not running.” System (100) through the world wide web (internet) through a plurality of interfaces such as but not limited to telephone lines, cellular networks, satellite networks, or any other network interface that is available to access the world wide web (internet) reports (36) through the control device (101A) to user (108A) that “car is not running”. System (100) through the world wide web (internet) through a plurality of interfaces such as but not limited to telephone lines, cellular networks, satellite networks, or any other network interface available to access the world wide web (internet) through the control device (101A) asks user (108A) “Would you like to start car?” User (108A) using the control device (101A) responds “yes, start car.” Control device (101A) sends user's (108A) communication (37) of “yes, start car” through the world wide web (internet) through a plurality of interfaces such as but not limited to telephone lines, cellular networks, satellite networks, or any other network interface that is available to access the world wide web (internet) to system (100). System (100) receives user's (108A) response (37) of “yes, start car” via control device (101A) through the world wide web (internet) through a plurality of interfaces such as but not limited to telephone lines, cellular networks, satellite networks, or any other network interface that is available to access the world wide web (internet). System (100) through the world wide web (internet) through a plurality of interfaces such as but not limited to telephone lines, cellular networks, satellite networks, or any other network interface that is available to access the world wide web (internet) sends request (38) to car (103A) to “start car.” Car (103A) receives request (39) from system (100) through the world wide web (internet) through a plurality of interfaces such as but not limited to telephone lines, cellular networks, satellite networks, or any other network interface that is available to access the world wide web (internet), a command to “start car”. Car (103A) starts as per command from system (100). Car (103A) sends communication (40) to system (100) through the world wide web (internet) through a plurality of interfaces such as but not limited to telephone lines, cellular networks, satellite networks, or any other network interface that is available to access the world wide web (internet), status report that “car is running.” System (100) receives communication (41) from car (103A) through the world wide web (internet) through a plurality of interfaces such as but not limited to telephone lines, cellular networks, satellite networks, or any other network interface that is available to access the world wide web (internet), status report that “car is running.” System (100) sends communication (42) through the world wide web (internet) through a plurality of interfaces such as but not limited to telephone lines, cellular networks, satellite networks, or any other network interface that is available to access the world wide web (internet), to user (108A) via control device (101A) that “car is running.”

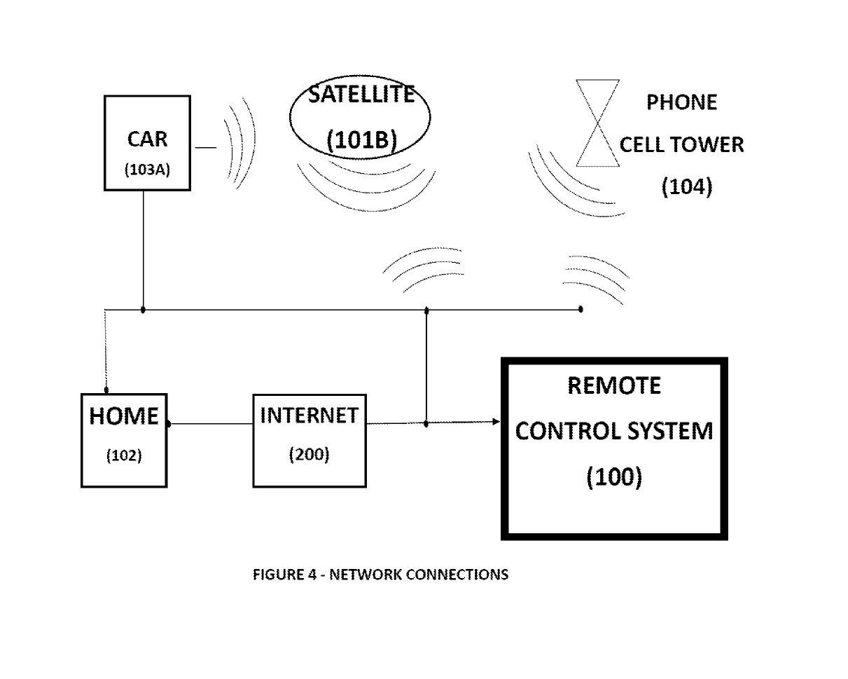

FIG. 4 shows an example of some network connections currently available to the system. Cloud Based Remote Control System (100) can remotely control Home environment (102), Car environment (103A) via the Internet (world wide web) (200) using Satellite networks (101B) or Cellular Networks (101C), or any other network used to access the Internet (200) now or future networks that is available to access the world wide web (internet).

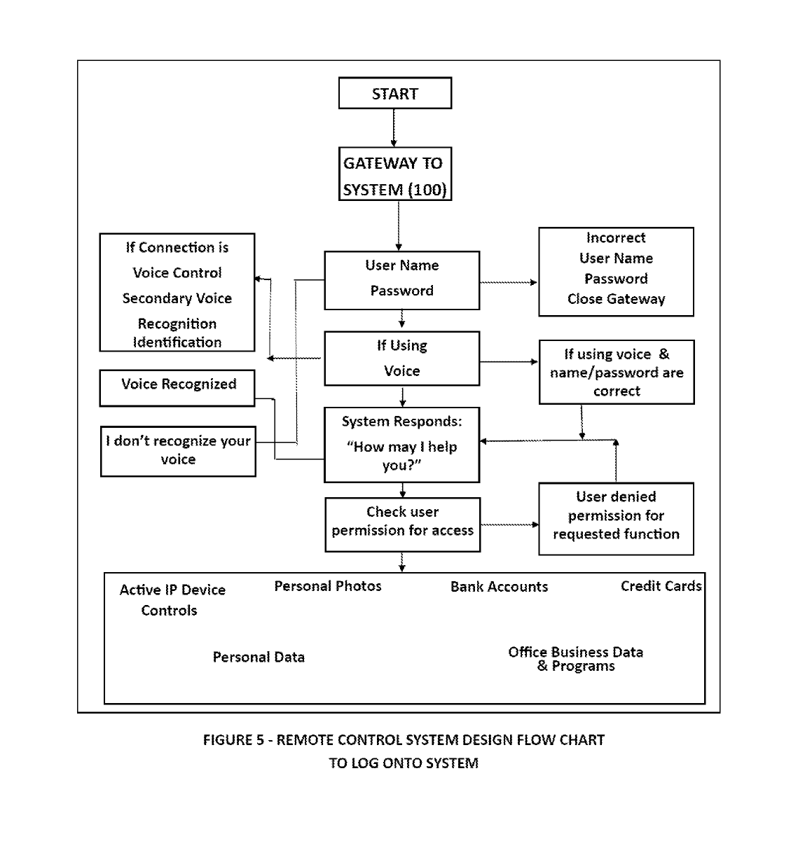

FIG. 5 shows the typical flow chart for logging on to the Cloud Based Remote Control System (100).

### INDUSTRIAL APPLICABILITY

The public domain is even larger in spectrum as it relates to this patent. This cloud based remote control system can be broadened in scope to include commercial applications. Companies will be able to control unmanned vehicles, public transportation, commercial or private aircraft, manufacturing plants, assembly lines, robotic equipment, public building system controls, fire and safety systems, to name a few, as well as remotely maintaining and organizing any data programs and records associated with the businesses.

This cloud based remote control system will allow equipment manufacturers and software developers to design their products to seamlessly connect to this remote control system, allowing for a universal standard that all hardware and software can be manufactured under in the future. Any hardware or software designed using the remote control system specifications and standards will automatically work within the remote control system. This patent proposes the use of a standardized system by which software companies and manufacturing companies of Personal Universe Control System (PUCS) compatible equipment alike will adhere to the same specifications and standards so that all equipment and software is universally compatible with the Personal Universe Control System (PUCS), much like Bluetooth has become the wireless standard for cell phones, computers and laptops.

### NON PATENT LITERATURE

### Nexia—Home Intelligence Design

http://www.gokeyless.com/product/2046/5/schlage-nexia-be369grnxcam619-starter-kit
Honeywell—Wireless focusPro Systems
http://www.forwardthinking.honeywell.com/products/wireless/focus pro/focus pro feature.html

### Shaki—Freedom of Mobility

http://arsalanstien.webs.com/

### Chevy—MyLink

http://gmauthority.com/blog/2010/10/chevy-unleashers-mychevrolet-onstar-mylink-apps-for-iphone-and-android-devices/

1. A system:
Whereby any electronic device can be remotely controlled.
Whereby an electronic device is defined as any electronic or electromagnetically controlled device or a device that is capable of being remotely controlled.
Whereby said system can be accessed or controlled by an electronic device, display device, or by voice command on a phone, mind control device, or other devices that are able to be used to access the world wide web (internet) through telephone lines, cellular network, satellite network, or any other network interface available to access the world wide web (internet).
Whereby said system is comprised of devices that can be manually or auto-configured and installed into the system.
Whereby said system contains a universal set of binary commands to remotely control all electronic devices with a unique identifying address such as an IP address.
Whereby said system can accept a plurality of inputs including but not limited to an electronic device, display device, or by voice command on a phone, mind control device, or other devices to remotely control any electronic device with a unique identifying address such as an IP address.

2. The system in claim 1 can remotely access, interact and store any data or programs.

3. The system in claim 1 combines remote control of electronic devices, data, data storage, programs, and security systems, enabling them to interact.

4. The system in claim 1 whereby all electronic devices with a unique identifying address such as IP addresses can be manufactured to make them universally compatible with a remote control system.

5. The system in claim 1 will allow any existing electronic or electromagnetically controlled device with a unique identifying address such as an IP address to be upgraded to be compatible with said system in claim 1.

6. In the system described in claim 1 some devices installed in the system are deemed by the system to be control devices (by definition a control device is a computing device, display device, or by voice command on a phone, mind control device, or other devices that can remotely control other devices and data in its environment when those devices are not directly connected to the system).

7. The system in claim 1 whereby an application can be downloaded onto a control device whereby said control device can control other devices when connection to the system is not available and can update the system when connection to the system is re-established.

8. The system in claim 1 has security features in that some devices installed into the system can only communicate with the system and be controlled by the system.

9. The system in claim 1 enables all devices to interact with one another. Multiple devices can interact based on pre-defined parameters. In addition, devices can be caused to interact or be controlled at pre-set times set by the user.
(For example, a carbon monoxide detector located in a garage that detects the presence of carbon monoxide can be configured to trigger the garage door opener to open the garage door so that the carbon monoxide can escape. This is a useful application that makes safety sense. However, a carbon monoxide detector that detects carbon monoxide can also be configured to trigger the coffee pot to turn on 5 minutes after the carbon monoxide detector detects the presence of carbon monoxide. Although this is not a practical usage of the system, it shows the flexibility offered by the system.)

10. The system in claim 1 authenticates voice prior to executing voice commands to verify that the commands are from an authorized user.

11. In claim 1, whereby a control device installed in the system will send messages or contact multiple recipients, including emergency services and/or authorized user(s) or designated personal contacts of the user(s) based on pre-defined criteria, wherein said message can include but not limited to GPS location.

12. The system in claim 1 will allow for a plurality of remote controls that can work simultaneously for an electronic or electromagnetically controlled device.
(Example: A user can use the system in claim 1 to remotely control a TV. However, the same TV can also be controlled simultaneously by the infrared remote controller or any other remote controller for the TV supplied by the TV manufacturer.)

13. In one embodiment in the system of claim 1 the user can schedule devices to be controlled on a pre-set time schedule.
the world wide web (internet) including but not limited to telephone lines, cellular network, satellite network, or any other network interface available to access the world wide web (internet), confirmation that installation is complete.
Sending by a cloud computing device to control device, through a plurality of connections used to access the world wide web (internet) including but not limited to telephone lines, cellular network, satellite network, or any other network interface available to access the world wide web (internet), installation confirmation.
Receiving, by control device, from a cloud computing device, through a plurality of connections used to access the world wide web (internet) including but not limited to telephone lines, cellular network, satellite network, or any other network interface available to access the world wide web (internet), confirmation of installation.

15. A method of claim 1 to turn on a device, comprising:
A request from a control device, computing device, display device, or by voice command on a phone, or mind control device, initiating a request to a cloud computing device, through a plurality of connections used to access the world wide web (internet) including but not limited to telephone lines, cellular network, satellite network, or any other network interface available to access the world wide web (internet), to turn on a device.
Receiving a request from a control device, computing device, display device, or by voice command on a phone, or mind control device, by a cloud computing device, through a plurality of connections used to access the world wide web (internet) including but not limited to telephone lines, cellular network, satellite network, or any other network interface available to access the world wide web (internet), to turn on a device.
Initiating, by a cloud computing device, the instructions to turn on said device.
Sending by a cloud computing device to said device, through a plurality of connections used to access the world wide web (internet) including but not limited to telephone lines, cellular network, satellite network, or any other network interface available to access the world wide web (internet), the instructions to turn on said device.
Receiving by said device from the cloud computing device, through a plurality of connections used to access the world wide web (internet) including but not limited to telephone lines, cellular network, satellite network, or any other network interface available to access the world wide web (internet), the instructions to turn on said device.
Sending from said device to cloud computing device, through a plurality of connections used to access the world wide web (internet) including but not limited to telephone lines, cellular network, satellite network, or any other network interface available to access the world wide web (internet), confirmation that said device has been turned on.
Sending by a cloud computing device, to the control device, through a plurality of connections used to access the world wide web (internet) including but not limited to telephone lines, cellular network, satellite network, or any other network interface available to access the world wide web (internet), confirmation that said device has been turned on.
Receiving, by control device, from a cloud computing device, through a plurality of connections used to access the world wide web (internet) including but not limited to telephone lines, cellular network, satellite network, or any other network interface available to access the world wide web (internet), confirmation that said device was turned on.

16. A method of claim 1 of initiating a command by a control device, comprising:
A control device, initiating a voice command request to a cloud computing device, through a plurality of connections used to access the world wide web (internet) including but not limited to telephone lines, cellular network, satellite network, or any other network interface available to access the world wide web (internet), to turn on a device and send video to a selected display.
Receiving a voice command request from a computing device, display device, or by voice command on a phone, or mind control device, by a cloud computing device, through a plurality of connections used to access the world wide web (internet) including but not limited to telephone lines, cellular network, satellite network, or any other network interface available to access the world wide web (internet) to turn on a device and send video to a selected display.
Initiating a voice command request from a computing device, display device, or by voice command on a phone, or a mind control device, by a cloud computing device, the voice command instructions to turn on a device and send video to a selected display.
Sending by cloud computing device to said device, through a plurality of connections used to access the world wide web (internet) including but not limited to telephone lines, cellular network, satellite network, or any other network interface available to access the world wide web (internet), the voice command instructions to turn on a device and send video to a selected display.
Receiving the voice command instructions by said device from the cloud computing device, through a plurality of connections used to access the world wide web (internet) including but not limited to telephone lines, cellular network, satellite network, or any other network interface available to access the world wide web (internet), the voice command instructions to turn on said device and send video to a selected display.
Sending from said device the voice command instructions to cloud computing device, through a plurality of connections used to access the world wide web (internet) including but not limited to telephone lines, cellular network, satellite network, or any other network interface available to access the world wide web (internet), confirmation that said device has been turned on and video has been sent to selected display.
Sending by a cloud computing device, to the control device, through a plurality of connections used to access the world wide web (internet) including but not limited to telephone lines, cellular network, satellite network, or any other network interface available to access the world wide web (internet), confirmation that the device has been turned on and video has been sent to selected display.
Receiving, by control device, from a cloud computing device, through a plurality of connections used to access the world wide web (internet) including but not limited to telephone lines, cellular network, satellite network, or any other network interface available to access the world wide web (internet), confirmation that device has been turned on and video has been sent to selected display.

17. A method of updating the BIOS in a device, comprising:
A control device, initiating a request to a cloud computing device, through a plurality of connections used to access the world wide web (internet) including but not limited to telephone lines, cellular network, satellite network, or any other network interface available to access the world wide web (internet), to update the BIOS of a device.
Receiving a request from a control device, computing device, display device, or by voice command on a phone, or a mind control device, by a cloud computing device, through a plurality of connections used to access the world wide web (internet) including but not limited to telephone lines, cellular network, satellite network, or any other network interface available to access the world wide web (internet), to update the BIOS of said device.
Initiating, by a cloud computing device, the instructions to update the BIOS of said device.
Sending by a cloud computing device to said device, through a plurality of connections used to access the world wide web (internet) including but not limited to telephone lines, cellular network, satellite network, or any other network interface available to access the world wide web (internet), the instructions and updated BIOS file to said device.
Receiving by said device from the cloud computing device, through a plurality of connections used to access the world wide web (internet) including but not limited to telephone lines, cellular network, satellite network, or any other network interface available to access the world wide web (internet), the instructions and updated BIOS file.
Initiating, by said device, the instructions to update the BIOS of said device.
Sending from said device to cloud computing device, through a plurality of connections used to access the world wide web (internet) including but not limited to telephone lines, cellular network, satellite network, or any other network interface available to access the world wide web (internet), confirmation that said device BIOS has been updated.
Receiving by a cloud computing device by said device through a plurality of connections used to access the world wide web (internet) including but not limited to telephone lines, cellular network, satellite network, or any other network interface available to access the world wide web (internet), confirmation that said device BIOS has been updated.
Sending by a cloud computing device, to the control device, through a plurality of connections used to access the world wide web (internet) including but not limited to telephone lines, cellular network, satellite network, or any other network interface available to access the world wide web (internet), confirmation that said device BIOS has been updated.
Receiving, by control device, from a cloud computing device, through a plurality of connections used to access the world wide web (internet) including but not limited to telephone lines, cellular network, satellite network, or any other network interface available to access the world wide web (internet), confirmation that said device BIOS has been updated.

18. An auto-configuration system
whereby any electronic device with a unique identifying address such as an IP address can be automatically installed.
whereby said auto-configuration system is comprised of a two-part alpha-numeric code.
whereby the alpha portion of the two part code specifies the type of device (examples: car, plane, phone, unmanned vehicle, light switch, etc.) and the remote controls available for that individual device.
whereby the second part of the two-part code (numeric portion) is the unique identifying address such as an IP address of each individual device
whereby the numeric portion of the code is compatible with both IPv4 and IPv6
whereby as an additional security measure the auto-configuration can set up direct routing for communication.
whereby as an additional security measure the device broadcasting can be turned off or limited to specific routing.
whereby the device can be scanned and auto-configuration information can be directly transferred into a system including but not limited to a unique identifying address such as an IP address, type of device, or other information not currently defined.
whereby the BIOS can be upgraded and allow a device to be controlled remotely from the cloud computing device or by the remote control device that came from the manufacturer of the device.

19. The method in claim 17 whereby the BIOS of existing devices can be upgraded to make them compatible with system in claim 1.

20. The system in claim 1 uses a standard set of binary commands to remotely control all electronic devices with unique identifying addresses such as an IP address.
